(19) United States
(12) Patent Application Publication
(10) Pub. No.: US 2006/0222766 A1
(43) Pub. Date: Oct. 5, 2006

(54) Encapsulation system

(76) Inventors: Rolf Müller, Zurich (CH); Federico Innerebner, Zürich (CH)

Correspondence Address: BACHMAN & LAPOINTE, P.C., 900 CHAPEL STREET, SUITE 1201, NEW HAVEN, CT, 06510, US

(21) Appl. No.: 10/553,402

(22) PCT Filed: Apr. 16, 2004
(86) PCT No.: PCT/CH04/00235

§ 371 Date: Nov. 21, 2005

(30) Foreign Application Priority Data
Apr. 17, 2003 (DE) 103 18 040.0

(51) Int. Cl. B01J 13/02

(52) U.S. Cl. 427/213.3

(57) ABSTRACT

An encapsulating systems of particles consisting of a matrix or an envelope and a phase enclosed therein. The envelope can be obtained from very low-viscous, highly concentrated solutions and melted masses having a variable crystalline part and a variable network density. The encapsulation system is suitable for the encapsualation of moderately to low viscous liquids, especially hydrophobic active ingredients such as fragrances, aromatics and pharmaceutical active ingredients. The system enables the range of method parameters to be significantly increased compared to previous encapsulation systems improves the stability of the envelopes of the encapsulation systems, and enables the release characteristics to be influenced in a targeted manner.

### BACKGROUND OF THE INVENTION

The invention describes particle encapsulating systems consisting of a matrix or sheath, and a phase incorporated therein, wherein the sheath can be obtained from very low viscous, highly concentrated solutions or melts with varying crystalline content and with varying network density. The encapsulating system is suitable for encapsulating medium to low viscous liquids, in particular hydrophobic substances, such as aromas, fragrances and pharmaceutical agents, and, by comparison to previous encapsulating systems, permits a greatly expanded range of process parameters, more stable sheaths of the encapsulating systems, and a targeted influencing of the release characteristics.

While aromas and fragrances are as a rule relatively thin, oily fluids, this state is unsuitable for many industrial applications. Therefore, methods were developed to encapsulate these substances, converting them into a solid and easily dosed form that is readily miscible with other components, and also to enable the protection of the sensitive active substances. These active substances are here to be protected against the atmosphere, in particular against oxygen, since oxidation can result in rancidness, while on the other hand the object is to completely prevent the active substances from escaping the encapsulating system. In the case of aromas and perfumes, already the slightest loss in quantity can massively impair the quality, with in particular the so-called and popular top notes, which make the active substance attractive, are lost all too quickly. An encapsulating system is ideally expected to exhibit a constant quality over a prolonged period of time, be stable over a storage period and during transport, withstand unscathed any subsequent processing steps, such as preparation with additional components, wherein the particles can be exposed to solid to liquid substances, temperature, pressure and shearing forces, wherein the active substance is released at exactly the time the consume expects, in particular released in a way the customer wants. For example, a bowl of soup should release its aroma completely when served, and not already lose its appeal in the cooking process; a piece of gum should retain its freshness and flavor for a longer period of time, and not become unattractive after only a minute. In the same vein, fragrances are expected to stay fresh and give us pleasure for a prolonged period of time. In other words, it should be possible to release the active substances from the particles in a controlled manner, with requirements ranging from fast and intense to slow and consistent.

Numerous methods for the particular encapsulation of medium to low-viscous liquids have been proposed, but only a handful of processes have become commercially viable, since most of the proposed solutions are unable to satisfy the stringent requirements, or there are inadequacies relative to the protection of particular content, stability against atmospheric humidity and temperature, and stability during further processing or release kinetics, the matrix or sheathing substances are not available at grocery stores and pharmacies, or the method is too complicated, tricky or cost intensive.

The most known and most often used technology for encapsulating aromas and perfumes involves the spray-drying of aqueous emulsions of these substances, wherein the matrix usually consists of dextrins, maltodextrins, modified starch, rubber arabicum or a combination thereof. However, this technology only enables a modest charging of particles with active substances, and a minimal protection of aromas, since the matrix obtained is porous and exhibits defects. As a result, the active substances lose intensity, freshness and quality. In addition, the particle surface has some non-encapsulated, and hence unprotected, active substance, which can oxidize, and hence become rancid. Further, the mentioned matrix or sheathing substances are exceptionally hydrophilic, so that their water content increases with atmospheric humidity, giving rise to a tackiness that causes clumps to form and impairs the free-flowing properties. Additional problems inherent in the standard technology are that the emulsions exhibit very high amounts of water, that must be evaporated, wherein the frequently heat-sensitive active substances are adversely impacted or escape, producing a porosity. The high content of water in the emulsion stems from the fact that the as a rule low viscosity of the dispersed phase of the active substance in emulsions must be the same order of magnitude compared with the viscosity of the matrix. Since the matrix consists of a solution or melt of polysaccharides, e.g., macromolecules, its viscosity is comparatively high. It can be reduced within certain limits by using hydrolyzed short-chained polysaccharides down to sugars, along with a higher amount of water. However, an increasing degree of polysaccharide hydrolysis is accompanied by a rise in its water solubility, a decrease in particle stability during various further processing steps, and in the end makes it virtually impossible to influence the release characteristics. As evident from the above, the various parameters for the recipe and the method are contradictory, so that high-quality encapsulating systems must face a wide range of difficulties. The encapsulation of aqueous emulsions satisfies only minimal requirements, but is a standard procedure, since improvements are very difficult, and can only be introduced by a few experts with specialized know-how.

U.S. Pat. Nos. 4,499,112 and 4,707,367 describe an improved encapsulating system. In this case, a disperse mixture of active substances with an aqueous polysaccharide solution or melt is pressed through a perforated die into a dehydrating, undercooled liquid, e.g., isopropanol. The mixture hardens rapidly in the process, and is mechanically broken down into small particles, separated form the liquid, and then gently dried for a longer period of time. A good encapsulating quality can be obtained with this technology; in particular the active substance adhering to the particle surface is rinsed away. However, disadvantages to this process include the high manufacturing costs, the low glass transition temperature of the matrix, and the pronounced hydrophilia of the matrix material, which leads to a diminished stability relative to temperature and atmospheric humidity. The release characteristics can only be influenced within narrow limits.

U.S. Pat. No. 6,607,771 describes another improved method. An aroma compound fabricated according to the method described in U.S. Pat. Nos. 4,499,112 and 4,707,367 is here dispersed via extrusion in an aqueous polysaccharide melt, after which this mixture is granulated and conditioned. This makes it possible to obtain an improved encapsulating quality, in particular ensuring good aroma protection. However, the improved protective sheathing here reduces the degree of charging, and the method is highly complex. The additional procedural steps do yield a high-quality encapsulation, but also an expensive encapsulating system.

While high potential for generating high-quality encapsulating systems is attributed to another method, coacervation technology, practical implementation has not yet taken place other than in niche areas, because no actually suitable matrix materials have yet been found for this purpose. In addition, the method is still very cost-intensive, at least at this point.

The existing solutions for encapsulating aromas and perfumes, in particular the cost-effective and easily mastered methods, yield products that are unstable relative to temperature and atmospheric humidity. Limited shelf life is the result, or involved measures must be taken to ensure protection against moisture and temperature. Aromas are often exposed to raw processes during food manufacture (e.g., baking, roasting, boiling extrusion), which impair the aroma properties. The polysaccharides and sugar used as the matrix materials enable very good oxygen and aroma barriers given intact particles, but the particles dissolve rapidly in aqueous media, thereby releasing the active substances, which partially escape before coming into use. Therefore, they are only suitable for a controlled release of active substances. U.S. Pat. No. 4,885,175, U.S. Pat. No. 4,978,537 or U.S. Pat. No. 5,997,659 describe systems for the controlled release of active substances. However, the corresponding methods are very cost-intensive, and apply only to niche applications.

With respect to a slow and lasting release of aroma in chewing bum and the like, U.S. Pat. Nos. 4,885,175, 4,978,537 or 4,887,659 have proposed encapsulating systems, but since these have not been implemented, there are still no good solutions.

### SUMMARY OF THE INVENTION

The currently available encapsulating systems only partially satisfy the commercial and technical requirements and customer wishes. Described below are new encapsulating systems that, by comparison to prior art, enable an improved property profile, provide a greater leeway with respect to the manufacturing processes, and permit an adjustment of release characteristics.

### DETAILED DESCRIPTION

As in most previous encapsulating systems, a matrix consisting of polysaccharides and sugars is here obtained. However, the polysaccharides used here differ from the previously used polysaccharides in that they partially crystallize and form networks in the process, wherein macromolecule agents interconnect various crystallites. The property of forming networks or gels is a typical one for numerous polysaccharides, but longer-chained polysaccharides having at least a share of linear chain segments are required for this purpose. However, increasing chain length is accompanied by a disproportionately high rise in the viscosity of aqueous solutions and melts of such polysaccharides, while the encapsulating technologies require the lowest possible viscosities. The normally used polysaccharides, like dextrins and maltodextrins, are strongly hydrolyzed, i.e., exceptionally short-chained, however, and dextrins in particular are additionally so strongly branched as to make crystallization and networking impossible for this reason as well. For example, this is manifested in the very good water solubility of the matrix obtained from these substances.

The feature common to all encapsulating systems according to the invention is that the matrix has at least one specific type of polysaccharide. To this end, use is made of polysaccharide Pi with a low degree of branching, preferably a completely linear one, which has a polymerization degree DP>7 and <100, preferably <70, more preferably <50, most preferably <30. Such polysaccharides are very readily crystallized. At a DP of 50, for example, the solutions still exhibit very low viscosities, even at concentrations of 50% or more, and are at least metastable at moderate temperatures. As a result, the low viscosities of the matrix can be set without any problem even at high concentrations, i.e., at advantageously low water contents. If the water content of the matrix is reduced, e.g., when spray drying an emulsion consisting of active substance and aqueous matrix, the polysaccharide P1 crystallizes in the form of nano- and microcrystallites, which agglomerate and form a sheath around the encapsulated active substance phase.

If starch with a DP—20, a typical short chain amylose (CSA), is used for P1, for example, highly concentrated solutions can be obtained, e.g., which are stable for several minutes at a concentration of 50% at 60° c., have a viscosity in the area of water of around 1 cP, and go into solution again after crystallization only at temperatures exceeding 120° C. The crystallization conditions stem primarily form the interplay between the drying rate and molecular weight of P1, wherein crystallization at increasing drying rates is possible as the DP decreases. At a DP—20, cooling rates of around 200° C./s are necessary to obtain P1 in an amorphous state, so that these P1 are easy to crystallize even at the high drying rates during spray drying. Even though the polysaccharide P1 is water soluble and exceedingly hydrophilic up to high concentrations, the particle sheath formed from it is insensitive to atmospheric humidity owing to the high crystallinity typically measuring 50%, and while the temperature sensitivity of previous amorphous polysaccharide sheaths is related to the low Tg of this amorphous phase, the minimal amorphous content of the particle sheath consisting of agglomerated nano- and microcrystallites nearly maximizes the temperature resistance of such encapsulating systems. The sorption isotherms of the nano- and microcrystalline agglomerates is much flatter by comparison to the sorption isotherms of primarily amorphous polysaccharides, comparatively much less water is absorbed with increasing atmospheric humidity, and no tackiness arises even at very high atmospheric humidity. During the use of the encapsulating systems, i.e., in aqueous media, the agglomerates of the nano- and microcrystallites break down, thereby releasing the active substance. The quality of the particle sheath, its mechanical strength, the stability, the release rate in the end application and the barrier effect relative to the atmosphere and active substance is determined to a great extent by the parameters of the drying process for the aqueous matrix on the one hand, in particular by the temperature and drying rate. On the other hand, additional substances can be used to exert a specific influence, which enables a specific control over the quality of the encapsulating systems. These additional substances are divided into three groups.

On the one hand, the matrix containing at least one polysaccharide P1 can also have at least one additional polysaccharide P2, preferably short-chained, i.e., low-viscous in the solution or melt, such as dextrins or maltodextrins with a correspondingly high dextrose equivalent DE, characterized in that it forms a primarily amorphous phase in the solid state. Therefore, types of polysaccharides P2 can be selected from the range of polysaccharides previously used for encapsulating systems that are preferred in terms of the requirement for a low viscosity of the matrix in the solution or melt state. At least a partial separation of P1 and P2 takes place in the matrix during the drying process. The scope of phase separation depends on the structural sizes of P2, the molecular weight ratio between P1 and P2, and on the drying parameters. A high irregularity of the steric structure of P2, such as a high branching degree, which can be >>5% for dextrins, or modifications like hydroxyl group substitution, a large difference in molecular weights and a low drying rate facilitate phase separation, which can be controlled via these parameters.

Given a complete phase separation, a share of an amorphous phase consisting of P2 is obtained in addition to the nano- and microcrystallites in the matrix. This share can be determined by the recipe with the quantity A2 of P2. The particle sheath compactness can be positively influenced as a result on the one hand by lowering the porosity of the nano- and microcrystalline agglomerates of P1, and having the amorphous phase act as an adhesive between P1 crystallites and crystallite agglomerates. On the other hand, an increasing share of P2 is accompanied by a rising sensitivity of the matrix to temperature and atmospheric humidity. However, even at an A2 of around 50%, this problem is clearly mitigated in comparison to prior art; in particular, tackiness only arises even then at relative atmospheric humidities RH exceeding 90%, while previous matrixes based on polysaccharides already posed a problem at an RH˜50%. The release characteristics can be influenced in addition to the process parameters with the share of P2. Given a high share of P2, a release comparable with previous encapsulating systems is obtained, i.e., the active substance is released very rapidly in an aqueous medium. As the share of A2 drops, the release rate v first slows, since the crystallites of P1 are insoluble, and the diffusion paths for water between the crystallites get longer. At low shares of A2, v is increasingly determined by the porosity of the crystallite agglomerates of P1. Given a high porosity, v tapers off again after reaching a maximum. At a low porosity, v can also rise steadily up to a maximum at A2=0. A similar behavior can be observed with respect to permeability relative to gases and active substance. Given a high share of A2, the permeability of the matrix corresponds to the permeability usually encountered for amorphous matrixes, while it advantageous decreases with a dropping share of A2, since the permeability of the crystalline phase is lower, while the matrix permeability rises again after a minimum given a significant porosity of the crystallite agglomerates toward lower shares of A2, and the minimum is reached at A2=0 at minimal porosity. Since such a minimal porosity is difficult to achieve, at least one minimal share of polysaccharides P2 is advantageously used, except in applications where a certain porosity is desired.

While polysaccharides can be incorporated into crystallites of P1 given a partial phase separation, the S2 sequences of P2 are advantageously incorporated into the crystallites of P1 on a regular basis. The precondition for the above is the presence of S2 sequences with a polymerization degree of DP>7, preferably >10, more preferably >12, wherein these sequences are linear, built form the same monomer units as P1, and not modified. This precondition is satisfied for numerous dextrins and maltodextrins, for example, where the sequences mostly represent regular side chains. The portion of the P2 macromolecule leading away from the side chain or the two parts of P2 leading away from the sequence S2 are then a constituent of the amorphous phase comprised of additional macromolecules P2. This makes it possible to achieve an effective phase switching between the crystalline phase of crystallites of primarily P1 and the amorphous phase of primarily P2, thereby positively influencing the quality of the particle sheath. For example, their strength and stability relative to moisture and temperature increases at a constant share of P2 with the degree of the described phase switching, while the release rate v decreases.

With respect to the second group of substances wherein the quality of the encapsulating systems can be specifically controlled, the matrix having at least one polysaccharide P1, if necessary at least one second polysaccharide P2, can be accompanied by at least one additional polysaccharide P3, which is characterized by the fact that it has a sequence with DP>100 and/or at least two type S2 sequences. Therefore, P3 can be a long chain amylose (LCA) with a DP>100, or a dextrin or maltodextrin with at least two type S2 side chains. With respect to phase separation during the drying process, the aforementioned correlations can also be applied similarly to mixtures of P1 and P3, except for one essential difference. Due to the specified conditions relating to the structural dimensions of P3, the probability for a regular incorporation of P3 sequences into P1 crystallites is elevated on the one hand. On the other hand, a new situation here arises in which two different sequences of P3 are regularly incorporated into two different P1 crystallites. As a result, these crystallites are crosslinked with each other, and a three-dimensional network comes about, wherein the P1 crystallites represent the node points, and P1 represents the bonds between the node points. The amount of P3 not incorporated into the P1 crystallites, which is generally the predominant percentage, from an amorphous phase between the crystallites that is comparable to the amorphous phase of P2 in terms of its properties and influence on the behavior of the matrix at a minimal coupling of crystallite. However, an increased coupling gives rise to a qualitatively new behavior, wherein low release rates v are obtained that earlier were hardly conceivable or only achievable with complicated encapsulating systems. The dissolution rate of the amorphous phase initially drops off distinctly as coupling increases, and the diffusion of uncoupled macromolecules of P3, and if necessary of P2, is hampered, thereby resulting an a breakdown of the sheath proceeding from the particle surface to the active substance. At higher degrees of coupling, the share of soluble components decreases, and dissolution is replaced by a swelling process, wherein the sheath becomes a gel that becomes mechanically unstable above a swelling level, and breaks down under a slight load. This further reduces the release rate, and distinctly increases stability relative to a non-crosslinked matrix during the preparation of the encapsulating system. At even higher coupling levels, the stability of the swelled sheath increases up to a state where the gel of the swelled sheath solidifies, breakdown no longer takes place, or only does so under a strong load. This illustrates that a wide range of release rates can be set. Stability relative to temperature and atmospheric humidity is elevated in systems containing a polysaccharide P3 in addition to the polysaccharide P1 relative to systems containing a polysaccharide P2 in addition to the polysaccharide P1, in particular as regards tackiness.

In terms of process parameters, the properties of network matrixes are in turn primarily determined by the drying conditions, in particular the drying rate, wherein the coupling level decreases with an increasing drying rate given the same recipe. With respect to the type of polysaccharides P3, the coupling level increases with the share of predicted P3 sequences. In addition to the mentioned long chain amylose, gelling dextrins also satisfy the specified conditions. LCA is preferably used in small quantities, since solutions thereof rapidly become unstable at moderate temperatures with increasing concentration, and the viscosity also rises disproportionately at a DP>100. While gelling dextrins also form relatively stable solutions and melts at moderate temperatures even in high concentrations, their molecular weight, and hence their viscosity in the solution or melt, is generally higher than the viscosity of non-gelling, conventional dextrins, so that quantities thereof must be held low. The polysaccharides P3 must not necessarily be able to gel with each other, as is the case for LCA and gelling dextrins. Crystallinity is induced primarily with polysaccharides P1, and networks that are advantageous for this invention of novel encapsulating systems can be obtained in combination with dextrins and maltodextrins, which exhibit no gelling whatsoever even in high concentrations, wherein the outstanding feature of these networks lies in the fact that they can also be obtained from very low-viscous solutions and melts with high concentrations of P1 and P2 and/or P3, the viscosity of which can be set to values of a few cP at room temperature. This makes it possible to readily satisfy the underlying requirement with regard to viscosity during the manufacture of emulsions, according to which the viscosities of both phases must be roughly the same order of magnitude. The active substances used for encapsulation typically have viscosities ranging from 0.1 to 100 cP at room temperature.

The statements made with respect to encapsulating systems basically apply to any polysaccharides P1, P2 and P3, provided they each belong to the same group, or at least to closely related groups of polysaccharides, satisfy the indicated conditions, and can be sensibly used in the solution or melt thanks to their low viscosity. Polysaccharides P1, P2 and P3 are preferably selected from the starches, since the required types are commercially available in a wide variety of grades, in particular in food quality as well. In addition, these starches are clearly less expensive than other polysaccharides. Finally, type P2 and P3 starches partially subjected to lipophilic modification (octenyl succinates) are also available, so that the emulsifier is already present in the starch for the manufacture of emulsions with oily active substances.

The encapsulating systems according to the invention are characterized by a high stability relative to temperature and atmospheric humidity, and relative to exposure to loads during preparation with additional components. The tackiness of the particles can be markedly reduced, and shifted toward significantly higher atmospheric humidities, so that measures for protection against moisture and/or temperatures are no longer necessary, or at least distinctly simplified, under most conditions. The barrier effect of the matrix with respect to the active substance can be elevated in comparison to previous processes, and specifically optimized owing to the system flexibility. While the requirement for a very low viscosity of the aqueous solution or melt forming the matrix massively narrowed the possible range of recipes and processes, this requirement even fits the particulars of the invention in that the most important component of recipes according to the invention, the polysaccharide 1, naturally has a low molecular weight within the mono- and oligomer range, thereby enabling highly concentrated aqueous solutions of P1 in excess of 50% at moderate temperatures within a several cP range. This made it possible to expand the range of additional components, in this regard also enabling the use of higher molecular and higher viscous substances as previously commonplace, imparting new degrees of freedom to the optimization of other properties. On the other hand, the a priori low viscosity of the matrix makes it possible to reduce the quantity of water therein, thereby facilitating the drying process and reducing crack formation, or the process can be carried out at lower temperatures, which is very advantageous given the pronounced temperature sensitivity of the active substances. Also of great importance is the ability to specifically influence the release characteristics, wherein, for example, the aroma can be protected and held in while processing the particles with additional components into an intermediate or end product, and the top notes can be retained. The adjustable networks and new range with respect to viscosity permit an optimal adjustment between protection and release in individual systems. This is all the more important, since nearly every active substance requires a separate, specific adjustment of the recipe and process parameters.

In addition, an encapsulating system can be adjusted via the selection of P1 and/or P2 and the quantity of these polysaccharides in such a way that a developed network yields a higher strength of the particle sheath, and the crystalline share reduces solubility in water. During subsequent thermal preparation, e.g., a cooking extrusion process, a better protection of the aroma can then be ensured. Less strongly developed matrix networks are suitable for encapsulating systems of aromas used for instant soups with improved aroma experience, in that aroma release is triggered by optimizing the swelling time of the network forming the particle sheath in the period after cooking. This makes it possible to enhance aroma intensity and freshness. Matrixes with a high coupling and low swelling level, for example, are very much suitable for use in chewing gum. The crosslinking level of the matrix can even be increased to a point where a release is impossible even after swelling the particle sheath, since the swelling level is too low, the sheath too hard. During exposure to amylase, which is encountered in saliva, a matrix with a diameter of 0.5 mm—a so-called “max-trix”—can even withstand digestion for about one hour. The digestion time in the mouth can be set within broad limits by controlling the network density and particle size. An amount of rapidly released aroma and a particle size distribution range of the encapsulating system can hence be used to generate a rapid aroma flash, followed by an aftertaste that surprises by how long it lasts, wherein the aroma experience might end up disappearing with one last gasp.

The encapsulating material system according to the invention can basically be fabricated with the various existing manufacturing processes. Previous process limits can here be expanded, and improved active substance protection properties, more homogenous distributions and/or higher charging levels can be achieved. In addition, use can be made of new, simpler and less expensive methods, which could previously be applied only on a very limited scale given the viscosity problem, e.g., drop granulation (Droppo method). The precondition for emulsion viscosity here lies at <500 cP. This precondition can be easily satisfied with the emulsions used for the encapsulating systems according to the invention. Another potential method of encapsulation is provided by the central extrusion device, e.g., described in U.S. Pat. No. 3,015,128.

### EXAMPLES

Short chain amylose with a DP˜20 was dissolved at a concentration of 50% in a [translator's note: word missing in German), or advantageous dissolution process; reference is made to Patent Application Wo 03/035026 A2, which is hereby included. The obtained clear solution was then brought to a temperature of 70° C., and the viscosity was determined by pouring the solution through a funnel heated to 70° C. The time it took 25 ml of solution to flow through was found to be 3.1 seconds. The flow time of water through the same funnel heated to 25° C. came in at 1.8 seconds. A value of −1.5 cP was obtained from the above with the known viscosity for water measuring 0.89 cP at 25° C. in good approximation for the viscosity of the P1 solution with 0.89 x (3.1/1.8) cP. The solution remained stable at 70° C. for several minutes, i.e., clear and transparent. Turbidity set in thereafter. As cooling continued, the solution became increasingly opaque, finally turning into a white paste. Crystallite and crystallite agglomerates were revealed under a microscope by diluting these pastes with water. The crystallite size decreased with a rising cooling rate.

Simple dissolution processes in a beaker made it possible to manufacture solutions of various dextrins and maltodextrins as well as octenyl succinates, in part already at room temperature. An examination was performed on such starch derivatives with a DE ranging from about 5 to 70 provided by different manufacturers and based on various starches, e.g., potato starch, tapioca starch, and waxy maize starch. The solutions were heated to 60° C., and then cooled to 25° C. Analogous solutions were manufactured with various shares of SCA solutions, wherein the SCA solution was blended into the P2 and/or P3 solution by means of a magnetic stirrer. Except for at very high concentrations, no turbidity was observed during this mixing process, i.e., SCA was not found to precipitate. These mixtures were then also cooled to room temperatures. At regular intervals, the funnel method was used to measure the solution viscosity, wherein values ranging from 3 to 30 seconds were typically found, i.e., viscosities of 1.5 to 15 cP. Most of the solutions without SCA exhibited a viscosity that remained constant for hours to days, and were transparent. However, several dextrins underwent gel formation at higher concentrations. The addition of SCA led to distinct changes, which largely depended on the share of SCA. Already at shares of 5%, gel formation could be observed in several solutions that exhibited long-term stability in the absence of SCA. Hence, the corresponding starch derivatives could be identified as type 3 polysaccharides. The gel formation times could be varied within a period of seconds to days through the share of SCA. On the other hand, the gel formation times were highly dependent on the starch derivatives given a constant share of SCA. IN general, the gel formation times for starch derivatives with a higher viscosity were shorter, although exceptions were also found in starch derivatives that revealed advantageous structural properties for heterocrystallization with SCA. The gels could also be obtained in a wide range of gel starches; soft gels that already could be damaged through contact were obtained, along with numerous intermediate stages all the way to gels with strengths in the IMPa range. Also obtained were mixtures of SCA with starch derivatives that exhibited no gel formation even at high shares of SCA, remained low-viscosity and became turbid. Large differences are encountered for various starch derivatives relative to turbidity times too. Even if they turned completely white, these mixtures underwent no gel formation, with at most pastes being obtained at higher SCA shares. Typical SCA crystallites could again be observed under a microscope by diluting these pastes. The corresponding starch derivatives could be identified as type 2 polysaccharides based on the mixtures of starch derivatives with SCA that were turbid, but did not undergo gel formation. While it was discovered that a rising DE made it increasingly probable that a type 2 polysaccharide was present, this correlation also revealed good and usable exceptions, i.e., derivatives that enable an entire range of gel starches despite a very high level of hydrolysis and correspondingly low viscosity with the SCA during heterocrystallization.

Gelling and separating mixtures of SCA and starch were further dripped into liquid nitrogen and onto dry ice. Given suitable recipes, gels and dispersions of SCA crystallite could also be obtained in concentrated derivate solutions, even under these extreme cooling conditions. Finally, a liquid mixer was used to also fabricate emulsions, and stabilize them with emulsifiers in cases where no octenyl succinates were used. These emulsions were dripped into liquid nitrogen, onto dry ice and onto an 80° C. metal plate. Given a suitable recipe, it was possible under all conditions to obtain gels or mixtures of SCA crystallites and crystallite agglomerates with a range of breakdown rates in aqueous media. Among other things, the correlation between the SCA share of gels and their tackiness was also distinctly evident; even at a water content of 50%, practically no tackiness could be observed in the more solid gels. Tests relating to digestion kinetics were performed with a standardized solution (megazyme) of porcine pancreatic alpha amylase on dried particles milled to a range of sizes in a shaking bath at 37° C., wherein an analysis was conducted on particle weight loss as a function of digestion time. A weight loss of 50% was measured after roughly 4 hours as the extreme value for a particle size of 0.7 to 1.0 mm. As a whole, a clear correlation was discovered between the share of SCA and gel starch.

1-10. (canceled)

11. An encapsulating system comprises a matrix and a phase enclosed in the matrix, the matrix comprises at least one polysaccharide P1, wherein the polysaccharide P1 is substantially linear, is present in the matrix in at least a partially crystalline form, and has a polymerization degree of DP>7 and <100.

12. The encapsulating system according to claim 11, where DP is <70.

13. The encapsulating system according to claim 11, where DP is <50.

14. The encapsulating system according to claim 11, where DP is <30.

15. The encapsulating system according to claim 11, including at least one additional polysaccharide wherein the additional polysaccharide P2 has a viscosity in cP of <5000 in 50% aqueous solution at room temperature.

16. The encapsulating system according to claim 11, including at least one additional polysaccharide wherein the additional polysaccharide P2 has a viscosity in cP of <1000 in 50% aqueous solution at room temperature.

17. The encapsulating system according to claim 11, including at least one additional polysaccharide wherein the additional polysaccharide P2 has a viscosity in cP of <500 in 50% aqueous solution at room temperature.

18. The encapsulating system according to claim 11, including at least one additional polysaccharide wherein the additional polysaccharide P2 has a viscosity in cP of <100 in 50% aqueous solution at room temperature.

19. The encapsulating system according to claim 11, wherein the encapsulating system has a polysaccharide P2 which is in primarily amorphous form in the solid state, and has A sequences with a polymerization degree of DP>7, where DP is >7 and wherein the A sequences are incorporated regularly in P1 crystallites during heterocrystallization with the polysaccharide Pi.

20. The encapsulating system according to claim 11, wherein the encapsulating system has a polysaccharide P2 which is in primarily amorphous form in the solid state, and has A sequences with a polymerization degree of DP>7, where DP is >10 and wherein the A sequences are incorporated regularly in P1 crystallites during heterocrystallization with the polysaccharide P1.

21. The encapsulating system according to claim 11, wherein the encapsulating system has a polysaccharide P2 which is in primarily amorphous form in the solid state, and has A sequences with a polymerization degree of DP>7, where DPF is >12 and wherein the A sequences are incorporated regularly in P1 crystallites during heterocrystallization with the polysaccharide P1.

22. The encapsulating system according to claim 11, wherein the encapsulating system has a further polysaccharide P3, and the polysaccharide P1 forms a network with the polysaccharide P3 during heterocrystallization.

23. The encapsulating system according to claim 22, wherein the share of P2 and/or P3 in % w/w relative to P1 and P2 and P3 ranges from 1 to 99.

24. The encapsulating system according to claim 22, wherein the share of P2 and/or P3 in % w/w relative to P1 and P2 and P3 ranges from 5 to 90.

25. The encapsulating system according to claim 22, wherein the share of P2 and/or P3 in % w/w relative to P1 and P2 and P3 ranges from 10 to 80.

26. The encapsulating system according to claim 22, wherein the polysaccharides P1, P2 and P3 are selected from the group consisting of starches, and P1 is selected from the group consisting of a short chain amylose, a linear dextrin, a limit dextrin, an amylodextrin, a Nageli dextrin, and an achrodextrin, P2 is selected from the group consisting of a hydrolyzed starch, a dextrin and maltodextrin, and P3 is selected from the group consisting of a long chain amylase, gelling dextrin, a hydrolyzed starch, a dextrin, and maltodextrin, wherein at least one of the starches can be amphiphilic.

27. The encapsulating system according to claim 22, wherein at least one of the starches is octenyl succinate.

28. A method for manufacturing an encapsulating system according to claim 11, wherein the process involves the following steps:
a) preparing of an aqueous solution or melt containing at least one polysaccharide P1 and, optionally, a polysaccharide P2 and/or P3 and/or additives like sugar, sugar types, mono- and oligosaccharides or polyols;
b) preparing of an emulsion of the solution in step a) with an active substance and optionally additional substances are selected from the group consisting of emulsifiers, antioxidants, stabilizers and mixtures thereof; and
c) forming particles from the emulsion in step b) by a process selected from the group consisting of spray drying, coacervation, dripping, and extrusion processes to produce the encapsulating system.

29. A process according to claim 28, further including cleaning the encapsulating system with anti-caking agents, and anti-cracking agents.

30. The encapsulating system according to claim 11, wherein the phase comprises an active substance, the active substance is selected from the group consisting of fragrances, aromas, pharmaceuticals, nutraceuticals, food additives, herbicides, fungicides, insecticides, pheromones, fungicides, and mixtures thereof.

31. A process according to claim 28, further including incorporating the encapsulating system into a final product selected from the group consisting of chewing gum, soups, beverages, milk products, pasteurized food products, candy, perfumes and perfumed articles.

32. The encapsulating system according to claim 11, wherein matrix has time release characteristics which are controlled by at least one of temperature, mechanical load, swelling rate, enzymatic hydrolysis, thereby ensuring a controlled release of the active substance.
